(19) United States
(12) Patent Application Publication
(10) Pub. No.: US 2008/0077969 A1
(43) Pub. Date: Mar. 27, 2008

(54) Receiver and decoding method of broadcast receiver

(75) Inventors: Koji Okada, Hino-shi (JP); Michihiro Fukushima, Fuchu-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/902,854

(22) Filed: Sep. 26, 2007

(30) Foreign Application Priority Data
Sep. 26, 2006 (JP) 2006-269972

(51) Int. Cl. H04N 7/16

(52) U.S. Cl. 725/151

(57) ABSTRACT

According to one embodiment, a broadcast receiver includes an operating section which outputs an operation signal of a channel, a tuner section which receives a digital broadcast signal of a specified channel and outputs a video/audio signal, a switch which receives the video/audio signal from the tuner section and outputs the signal to a later tier according to a command signal, a decoder section which decodes and reproduces the video/audio signal from the switch, and a controller which, when an operation signal for switching a first channel to a second channel is given from the operating section, turns off the switch at a first timing of the channel switching, changes the channel of the tuner section into the second channel, and turns on the switch at a second timing elapsed by a predetermined time from the first timing.

### CROSS-REFERENCE TO RELATED APPLICATIONS

This application is based upon and claims the benefit of priority from Japanese Patent Application No. 2006-269972, filed Sep. 29, 2006, the entire contents of which are incorporated herein by reference.

### BACKGROUND

1. Field

One embodiment of the invention relates to a broadcast receiver of a digital broadcast signal and a decoding method of the broadcast receiver.

2. Description of the Related Art

Recently, digital broadcast is becoming widely used, and a lot of digital broadcast receivers are being developed and used. In such digital broadcast receivers, since channel switching at the time of receiving digital broadcast requires Demux/I-Picture waiting time/VBV-delay due to a structure of MPEG (Moving Picture Expert Group), the channel switching in digital broadcast takes a longer time than analog broadcast.

Patent Document 1 (Jpn. Pat. Appln. KOKAI Publication No. 2005-184457) discloses that when a program is switched, the time at which an I-picture of a next program can appear is predicted and a currently displayed program is displayed until the time obtained by subtracting tuner setting time from that time in order to reduce a display disabled period as much as possible.

In the conventional technique of the Patent Document 1, however, when decoding is stopped/started before and after switching in order to prevent a useless image from being displayed at the time of channel switching, the switching waiting time becomes long.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A and 1B are block diagrams illustrating examples of constitutions of a broadcast receiver according to one embodiment of the present invention;

FIG. 2 is a flowchart illustrating one example of a decoding process at the time of channel switching without a characteristic of the present invention;

FIG. 3 is a flowchart illustrating one example of the decoding process at the time of channel switching in the broadcast receiver according to one embodiment of the present invention;

FIG. 4 is a timing chart illustrating examples of the decoding process at the time of channel switching in the broadcast receiver according to one embodiment of the present invention;

FIG. 5 is a timing chart illustrating another example of the decoding process at the time of channel switching in the broadcast receiver according to one embodiment of the present invention; and

FIG. 6 is a timing chart illustrating still another example of the decoding process at the time of channel switching in the broadcast receiver according to one embodiment of the present invention.

### DETAILED DESCRIPTION

Various embodiments according to the invention will be described hereinafter with reference to the accompanying drawings. In general, according to one embodiment of the invention, a broadcast receiver comprising: an operating section which outputs an operation signal of a channel; a tuner section which receives a digital broadcast signal of a specified channel and outputs a video/audio signal; a switch which receives the video/audio signal from the tuner section and outputs the signal to a later tier according to a command signal; a decoder section which decodes and reproduces the video/audio signal from the switch; and a controller which, when an operation signal for switching a first channel to a second channel is given from the operating section, turns off the switch at a first timing of the channel switching, changes the channel of the tuner section into the second channel, and turns on the switch at a second timing elapsed by a predetermined time from the first timing.

One embodiment of the present invention provides a broadcast receiver which reduces a display disabled period at the time of channel switching of digital broadcast and a decoding method of the broadcast receiver.

One embodiment for achieving the above object is a broadcast receiver including: an operating section (18) which outputs an operation signal of a channel; a tuner section (11) which receives a digital broadcast signal of a specified channel and outputs a video/audio signal; a switch (20) which receives the video/audio signal from the tuner section and outputs the signal to a later tier according to a command signal; a decoder section (15) which decodes and reproduces the video/audio signal from the switch; and a controller (19) which, when an operation signal for switching a first channel to a second channel is given from the operating section, turns off the switch (S21) at a first timing (t₁) of the channel switching, changes the channel of the tuner section into the second channel (S22), and turns on the switch (S24) at a second timing (t₂) elapsed by a predetermined time from the first timing (t₁).

As a result, when a switch in front of an encoder is turned off for a predetermined time after channel switching, an image of a previous channel can be separated from an image of a later channel. As a result, a stored image of the previous channel can be displayed, so that the display disabled period at the time of channel switching can be shortened.

An embodiment of the present invention will be described in detail below with reference to the drawings.

<Digital Broadcast Receiver According to One Embodiment of the Present Invention>

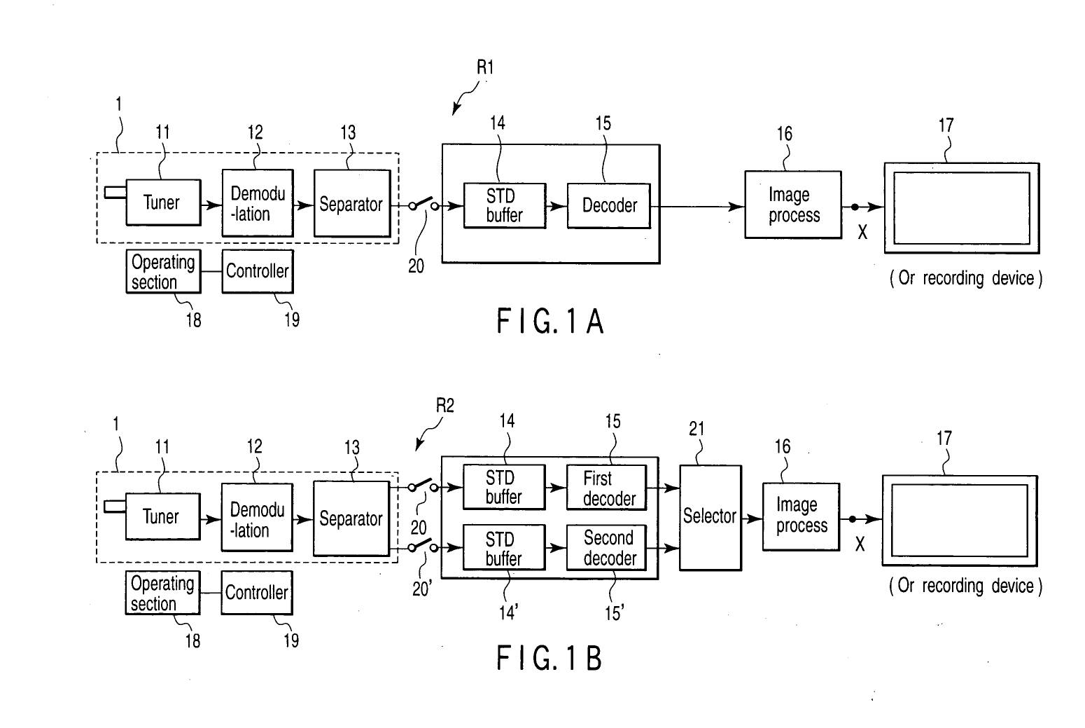

A digital broadcast receiver according to one embodiment of the present invention will be described in detail below with reference to the drawings. FIG. 1 is a block diagram illustrating one example of a constitution of the broadcast receiver according to one embodiment of the present invention.

(Constitution)

As shown in FIG. 1A, a digital broadcast receiver R1 according to one embodiment of the present invention has a tuner section 1 such as a digital ground wave tuner, a digital BS tuner and a digital CS tuner, a switch 20, an STD buffer 14, a decoder 15 such as an MPEG decoder, an image processor 16 and a display 17. The switch 20 receives a video/audio signal from the tuner section 1 and supplies the signal to a later tier. The STD buffer 14 temporarily stores therein the video/audio signal supplied from the switch 20. The decoder 15 decodes the video/audio signal. The image processor 16 enhances image quality of an output from the decoder 15 and executes a scale process on the output. The display 17 displays a video signal from the image processor 16 on a screen. A recording device which records the video signal from the image processor 16 is also desirable.

The tuner section 1 has a tuner 11, a demodulator 12 and a separator 13. The tuner 11 acquires a digital broadcast signal synchronous with a specified channel in digital broadcast signals supplied from an antenna or the like. The demodulator 12 demodulates the acquired digital broadcast signal and outputs an audio/video signal. The separator 13 separates the audio/video signal into an audio signal and a video signal.

The digital broadcast receiver R1 according to one embodiment of the present invention has an operating section 18 and a controller 19. The operating section 18 receives an operation signal of channel switching from a remote controller, not shown, and outputs the operation signal according to an operation using an operation switch of a main body. The controller 19 controls an entire operation according to the operation signal from the operating section 18.

As shown in FIG. 1B, a digital broadcast receiver R2 according to one embodiment of the present invention has a plurality of STD buffers 14 and 14′, a first decoder 15 and a second decoder 15′.

That is to say, as shown in FIG. 1B, the digital broadcast receiver R2 according to one embodiment of the present invention has a tuner section 1 such as a digital ground wave tuner, a digital BS tuner and a digital CS tuner, switches 20 and 20′, the STD buffers 14 and 14′, the first decoder 15 and the second decoder 15′ such as MPEG decoders, a selector 21, an image processor 16, and a display 17. The switches 20 and 20′ receive video/audio signals from the tuner section 1 and supply the signals to a later tier. The STD buffers 14 and 14′ temporarily store therein the video/audio signals supplied from the switches 20 and 20′. The first and second decoders 15 and 15′ decode the video/audio signals. The selector 21 selectively outputs the outputs from the decoders 15 and 15′. The video processor 16 enhances image quality of the output from the selector 21 and executes a scale process on the output. The display 17 displays the video/audio signal from the image processor 16 on a screen.

The digital broadcast receiver R2 according to one embodiment of the present invention further has an operating section 18 and a controller 19. The operating section 18 receives an operation signal of channel switching from a remote controller, not shown, and outputs the operation signal according to an operation of an operation switching of a main body. The controller 19 controls an entire operation according to the operation signal from the operating section 18.

The digital broadcast receiver R1 having such a constitution receives and reproduces digital broadcast in the following manner. That is to say, the demodulator 12 demodulates a digital broadcast signal synchronized by the tuner 11 under the control of the controller 19 according to a channel command signal supplied from the operating section 18, and outputs a video/audio signal. The video/audio signal is separated into a video signal and an audio signal by the separator 13. The video signal and the audio signal supplied to the STD buffer 14 via the switch S20 are decoded by the MPEG decoder of the decoder 15. Image quality of the decoded video signal is enhanced, or the video signal is subject to the scale process by the video processor 16 so as to be displayed on the display 17. The audio signal is amplified by an audio section, not shown, and is output to an external speaker via an external terminal, not shown.

<Decoding Process of the Digital Broadcast Receiver>

(Decoding Process at the Time of Channel Switching without Characteristic of the Present Invention)

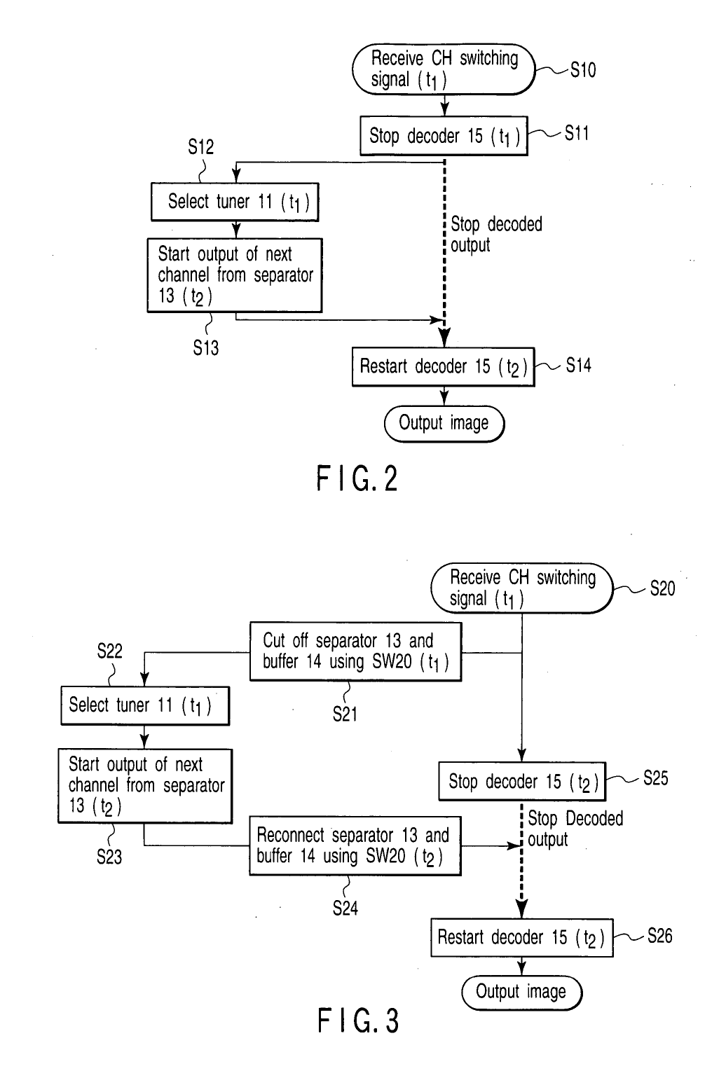

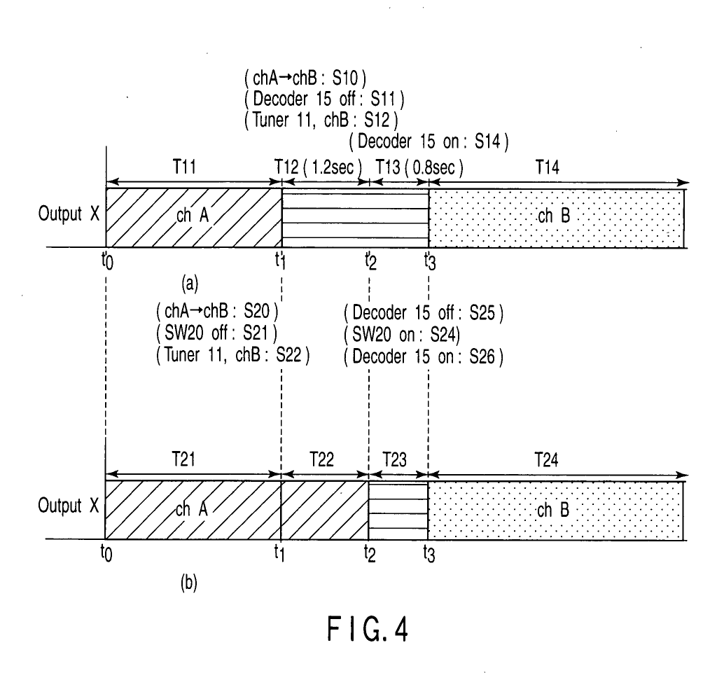

The decoding process without a characteristic of the present invention in the digital broadcast receiver having the above constitution will be described below with reference to a flowchart of FIG. 2. FIG. 2 is a flowchart illustrating one example of the decoding process at the time of channel switching without the characteristic of the present invention. FIG. 4A is a timing chart illustrating one example of the decoding process at this time.

When the broadcast receiver R1 receives a channel switching signal from an A channel to a B channel, for example, from the operating section 18 (step S10) in the flowchart of FIG. 2, the receiver. R stops the decoder 15 at timing (t₁) (step S11). The A channel is switched into the B channel in the tuner 11 at the timing (t₁) (step S12).

Output from the separator 13 of the B channel is started at timing (t₂) elapsed by a predetermined time from the timing (t₁) (step S13). At the timing (t₂), the operation of the decoder 15 is restarted (step S14). A predetermined time T12 is the time during which the video/audio signal of the previous A channel remains in the STD buffer 14.

With such a procedure, an output X of FIG. 1 is supplied to the display 17 at the timing shown in FIG. 4A. That is to say, the A channel is displayed for a period T11, and a black image is displayed for the period T12 (for example, about 1.2 seconds). The black image is displayed also for a period T13 (for example, about 0.8 second), and the B channel is displayed for a period T14. The black image period at the time of channel switching is about 2.0 seconds.

Since this method performs the separation of the image of the A channel and the image of the B channel by means of stopping the decoder 15, the black image period at the time of channel switching becomes very long. It is an object of the invention to shorten the black image period (about 2.0 seconds) at the time of channel switching as much as possible and solve user's uncomfortable feeling at the time of channel switching.

(The Decoding Process at the Time of Channel Switching with the Switching Process)

The decoding process at the time of channel switching with the switching process in the digital broadcast receiver will be described below with reference to a flowchart of FIG. 3 and a timing chart of FIG. 4. FIG. 3 is a flowchart illustrating one example of the decoding process at the time of channel switching in the broadcast receiver according to one embodiment of the present invention. FIG. 4B is a timing chart illustrating one example of the decoding process at this time. The following respective steps in the flowchart of FIG. 3 can be replaced by circuit blocks, and thus all the steps of the flowchart can be redefined as blocks.

With this method, the switch in front of the encoder is turned off for a predetermined time after channel switching, so that the image of a previous channel is separated from an image of a later channel. As a result, a stored image of the previous channel can be displayed (without being mixed with the image of the later channel), so that the display disabled period at the time of channel switching can be shortened.

That is to say, when the controller 19 of the broadcast receiver R1 receives a channel switching signal from an A channel to a B channel, for example, from the operating section 18 in the flowchart of FIG. 3 (step S20), the separator 13 and the STD buffer 14 are cut off by the switch 20 at timing (t₁) (step S21). The A channel is switched into the B channel in the tuner 11 at the timing (t₁) (step S22).

The controller 19 of the broadcast receiver R1 starts output of the B channel from the separator 13 at timing (t₂) elapsed by a predetermined time from the timing (t₁) (step S23). The decoder 15 is stopped at the timing (t₂) (step S25). The controller 19 of the broadcast receiver R1 reconnects the separator 13 and the decoder 14 by means of the switch 20 at the timing (t₂) (step S24). The decoder 15 is then restarted at the timing (t₂) (step S25). The predetermined time T12 is time during which the video signal of a previous channel remains in the STD buffer 14.

The order of the stopping of the decoder 15 (step S25), the reconnection of the switch 20 (step S24) and the restart of the decoder 15 (step S26) should not be changed. This means that when the decoder 15 is suspended, the internal video/audio signal of the A channel is reset and the image of the A channel and the image of the B channel are prevented from being mixed.

It is, however, also desirable that the suspension of the decoder 15 (and restart of the decoder 15) at step S25 is omitted. In this case, the processing load is reduced by simplifying the operation, so that operation stability can be enhanced.

It is desirable that the timing (t₂) elapsed by a predetermined time from the timing (t₁) and timing (t₃) are determined by actually operating the digital receiver and repeatedly taking actual measurement values.

When the process with the switching process is executed, the output X of FIG. 1 is supplied to the display 17 at the timing shown in FIG. 4B. That is to say, the A channel is displayed for a period T21 and a period T22 (about 1.2 seconds), a black image is displayed for a period T23 (about 0.8 second), and the B channel is displayed for a period T44. The black image period at the time of channel switching is about 0.8 second, for example, and the time can be reduced to about 40%. During the black image period T23, it is preferable that image output is put on mute or a still image is output.

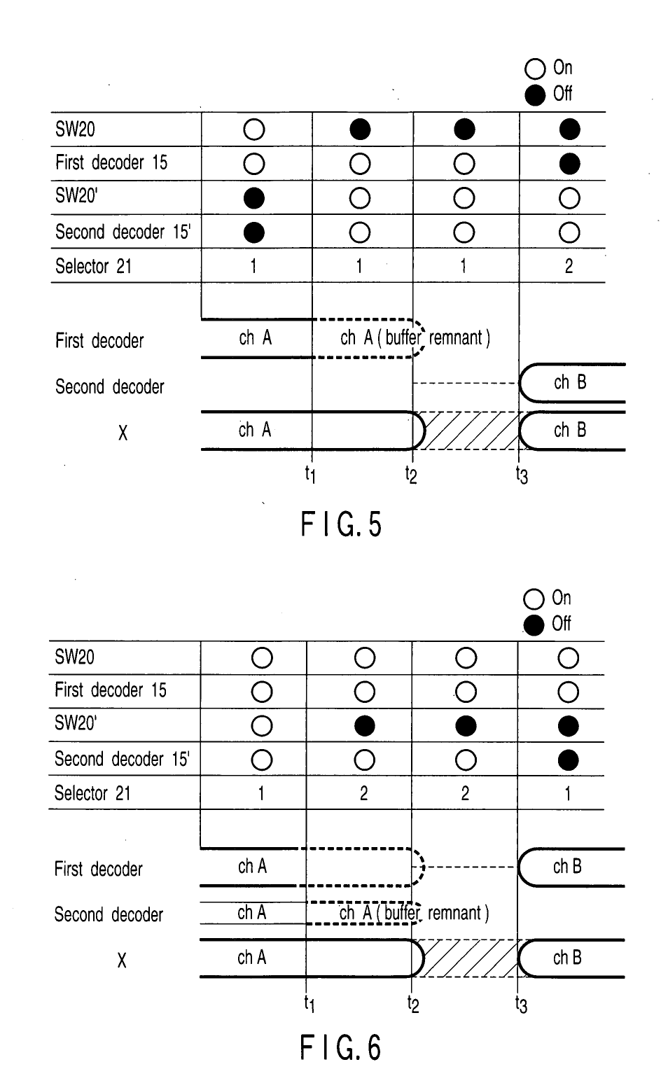

(The Decoding Process at the Time of Channel Switching by a Plurality of Decoders: FIG. 5)

The process by means of the plurality of decoders in the digital broadcast receiver R2 of FIG. 1B will be described in detail below with reference to FIG. 5. FIG. 5 is a timing chart illustrating another example of the decoding process at the time of channel switching in the broadcast receiver according to one embodiment of the present invention.

The decoding process of FIG. 5 is used for the video/audio process of the A channel before changing one decoder, and also for the video/audio process of the B channel after changing the other decoder.

That is to say, the decoding process at the time of channel switching by means of the plurality of decoders is executed by the controller 19 of the broadcast receiver R1. The decoding process is specified by a list showing the operations of the switch 20, the first decoder 15, the switch 20′, the second decoder 15′ and the selector 21 at respective timings. The white circle means an active state or a switch-on state, and the black circle means an inactive state or a switch-off state. “1” of the selector 21 means an output from the first decoder 15, “2” means an output from the second decoder 15′.

That is to say, the first switch 20 is on, the first decoder 15 is on, the second switch 20′ is off, the second decoder 15′ is off and the selector 21 selects the output from the first decoder 15 for the period (to t₁) of the A channel before channel switching.

The first switch 20 is off, the first decoder 15 is on, the second switch 20′ is on, the second decoder 15′ is on and the selector 21 selects the output from the first decoder 15 for the period (t₁ to t₂) during which the video signal of the A channel remains after the channel switching.

The first switch 20 is off, the first decoder 15 is on, the second switch 20′ is on, the second decoder 15′ is on and the selector 21 selects the output from the first decoder 15 for the period (t₂ to t₃) during which the video signal of the B channel is visible and audible after the remaining of the video signal of the A channel ends.

The first switch 20 is off, the first decoder 15 is off, the second switch 20′ is on, the second decoder 15′ is on and the selector 21 selects the output from the second decoder 15′ after the period (t₃ to) during which the video signal of the B channel is visible and audible.

The timing (t₂) elapsed by a predetermined time from the timing (t₁) and the timing (t₃) are desirably determined by actually operating the digital receiver and repeatedly taking actual measurement values.

As a result, in the method using the plurality of decoders, similarly to the decoding process of FIG. 3, since the decode output stopping period is shortened, the switching waiting time can be shortened. However, since the plurality of decoders are used independently, the possibility that the images of the A channel and the B channel are mixed becomes very low. Therefore, an operation margin becomes large, and thus higher operation stability is obtained.

(The Decoding Process at the Time of Channel Switching by Means of the Plurality of Decoders: FIG. 6)

The process by means of the plurality of decoders in the digital broadcast receiver R2 of FIG. 1B will be described in detail below with reference to FIG. 6. FIG. 6 is a timing chart illustrating another example of the decoding process at the time of channel switching in the broadcast receiver according to one embodiment of the present invention.

In the decoding process of FIG. 6, one decoder (large) is used for displaying a non-residual image and the other decoder (small) is used for displaying a residual image.

That is to say, one (small) of the decoders is used for displaying a video/audio signal remaining in the buffer connected to the decoder, and the other one (large) of the decoders is used for displaying a video/audio signal of the first channel before channel switching and displaying a video/audio signal of the second channel.

Namely, the decoding process at the time of channel switching by means of the plurality of decoders is executed by the controller 19 of the broadcast receiver R1. The decoding process is specified by a list showing the operations of the switch 20, the first decoder 15, the switch 20′, the second decoder 15′ and the selector 21 at respective timings shown in FIG. 6. The white circle means an active state or a switch-on state, the black circle means an inactive state or a switch-off state, “1” of the selector 21 means that output from the first decoder 15 is selected, and “2” means that output from the second decoder 15′ is selected.

The first switch 20 is on, the first decoder 15 is on, the second switch 20′ is on, the second decoder 15′ is on, and the selector 21 selects the output from the first decoder 15 for the period (to t₁) of the A channel before channel switching.

The first switch 20 is on, the first decoder 15 is on, the second switch 20′ is off, the second decoder 15′ is on, and the selector 21 selects the output from the second decoder 15′ for the period (t₁ to t₂) during which the video signal of the A channel remains after the channel switching.

The first switch 20 is on, the first decoder 15 is on, the second switch 20′ is off, the second decoder 15′ is on, and the selector 21 selects the output from the second decoder 15′ for the period (t₂ to t₃) during which the video signal of the B channel is visible and audible after the remnant of the video signal of the A channel ends.

The first switch 20 is on, the first decoder 15 is on, the second switch 20′ is off, the second decoder 15′ is off, and the selector 21 selects the output from the first decoder 15 after the period (t₃ to) during which the video signal of the B channel is visible and audible.

The timing (t₂) elapsed by a predetermined time from the timing (t₁) and the timing (t₃) are suitably determined by actually operating the digital receiver and repeatedly taking actual measurement values.

As a result, in the method using the plurality of decoders, similarly to the decoding process of FIG. 3, since the decode output stopping period is shortened, the switching waiting time can be shortened. Further, since the plurality of decoders are used independently, the possibility that the images of the A channel and the B channel are mixed becomes very low. For this reason, the operation margin becomes large, and high operation stability is obtained. Unlike the case of FIG. 5, in the mode of FIG. 6, in the case where the two decoders cannot offer the equivalent performance such as the case where the second decoder is small, residual images are desirably displayed by the second decoder.

A person skilled in art can realize the present invention based on the above various embodiments, but the person skilled in the art easily conceives various modified examples of these embodiments. Even if the person skilled in the art has no inventive ability, the present invention can be applied to various embodiments. Therefore, the present invention covers a wide range which does not conflict with the disclosed principle and new feature and thus is not limited to the above embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast receiver comprising:
an operating section which outputs an operation signal of a channel;
a tuner section which receives a digital broadcast signal of a specified channel and outputs a video/audio signal;
a switch which receives the video/audio signal from the tuner section and outputs the signal to a later tier according to a command signal;
a decoder section which decodes and reproduces the video/audio signal from the switch; and
a controller which, when an operation signal for switching a first channel to a second channel is given from the operating section, turns off the switch at a first timing of the channel switching, changes the channel of the tuner section into the second channel, and turns on the switch at a second timing elapsed by a predetermined time from the first timing.

2. The broadcast receiver according to claim 1, wherein the controller turns off the decoder section at the second timing, turns on the switch, and then turns on the decoder section.

3. The broadcast receiver according to claim 1, wherein the predetermined time between the first timing and the second timing is a period during which, even after the channel of the tuner section is changed, an image of the channel before the change is output as an output of the decoder section.

4. The broadcast receiver according to claim 1, further comprising a processing section which displays or records a decoding signal from the decoder section.

5. A broadcast receiver comprising:
an operating section which outputs an operation signal of a channel;
a tuner section which receives a digital broadcast signal of a specified channel and outputs a video/audio signal;
a first switch which receives the video/audio signal from the tuner section and outputs the signal to a later tier according to a command signal;
a first decoder section which decodes and reproduces the video/audio signal from the first switch;
a second switch which receives the video/audio signal from the tuner section and outputs the signal to a later tier according to a command signal;
a second decoder section which decodes and reproduces the video/audio signal from the second switch;
a selector section which receives reproducing signals from the first and second decoders and outputs one of the signals; and
a controller which controls the channel of the tuner section, the first switch, the second switch, the first decoder, the second decoder and the selector section so as to output a video/audio signal according to the channel operation signal from the operating section.

6. The broadcast receiver according to claim 5, wherein
when an operation signal for switching a first channel to a second channel is given from the operating section, the controller changes the channel of the tuner section into the second channel at a first timing of channel switching, and
the controller makes a control so that the first decoder is used only for a video/audio signal of the first channel, and the second decoder is used only for a video/audio signal of the second channel.

7. The broadcast receiver according to claim 5, wherein
when an operation signal for switching a first channel to a second channel is given from the operating section, the controller changes the channel of the tuner section into the second channel at a first timing of channel switching, and
the controller makes a control so that one of said plurality of decoders is used only for displaying a video/audio signal remaining in a buffer connected to the decoder, and the other decoder is used for displaying a video/audio signal of the first channel before the channel switching and displaying a video/audio signal of the second channel.

8. A decoding method in a broadcast receiver having an operating section which outputs an operation signal of a channel, a tuner section which receives a digital broadcast signal of a specified channel and outputs a video/audio signal, a switch which receives the video/audio signal from the tuner section and outputs the signal to a later tier according to a command signal, and a decoder section which decodes and reproduces the video/audio signal from the switch, the method comprising:
when an operation signal for switching a first channel to a second channel is given from the operating section, turning off the switch at a first timing of the channel switching;
changing the channel of the tuner section into the second channel; and
turning on the switch at a second timing elapsed by a predetermined time from the first timing so as to decode the video/audio signal.

9. The decoding method according to claim 8, wherein the decoder section is turned off at the second timing, the switch is turned on, and then the decoder section is turned on.

10. The decoding method according to claim 8, wherein the predetermined time between the first timing and the second time is a period during which, even after the channel of the tuner section is changed, an image of the channel before the change is output as an output of the decoder section.
